(19) United States
(12) Patent Application Publication
(10) Pub. No.: US 2016/0184822 A1
(43) Pub. Date: Jun. 30, 2016

(54) MICROFLUIDIC DEVICE FOR PARTICLE ENUMERATION

(71) Applicant: VOR, Inc., San Diego, CA (US)

(72) Inventors: TsungFeng WU, San Jose, CA (US); Yu-Chen CHEN, San Diego, CA (US)

(21) Appl. No.: 14/968,675

(22) Filed: Dec. 14, 2015

Related U.S. Application Data
(60) Provisional application No. 62/093,992, filed on Dec. 18, 2014.

(51) Int. Cl. B01L 3/00; G01N 15/06

(52) U.S. Cl. CPC B01L 3/502715; B01L 3/502761; G01N 15/06; B01L 2200/0668; B01L 2200/10; B01L 2300/0803; B01L 2300/0864; B01L 2300/088; G01N 2015/0693

(57) ABSTRACT

This invention relates to a microfluidic device for conducting automatic particle enumeration. The microfluidic device comprises an inlet, a microchannel, an outlet, multiple branched channels and a sensing channel. The microchannel has a plurality of loops. Each of the branched channels interconnects at least two adjacent loops. The particles in the fluid migrate toward an inner channel wall of the microchannel when the particles pass through the sensing channel. The sensing channel includes a staircase-shaped slit pattern for optical particle enumeration of the particles passing through the sensing channel.

### CROSS-REFERENCE TO RELATED APPLICATION

This application claims the benefit of U.S. Provisional Patent Application No. 62/093,992, entitled “MICROFLUIDIC DEVICE FOR PARTICLE ENUMERATION”, which was filed on Dec. 18, 2014, which is incorporated by reference herein in its entirety.

### FIELD OF THE INVENTION

This invention relates to a microfluidic device for conducting automatic particle enumeration. The microfluidic device can be a web-spiral microfluidic device that separates particles by sizes and trap microbubbles in the branched channels.

### BACKGROUND OF THE INVENTION

Point-of-care is widely recognized by the global health care community as a promising mechanism to address personalized medicine. Successful implementation of point-of-care relies on the availability of low cost, easy-to-operate, and accurate medical equipment suitable for point-of-care clinics. Particularly, devices for separating, filtering, or enumerating microparticles are important for clinical analysis in point-of-care scenario. However, the currently medical devices in the point-of-care form cannot address the needs of separations, filtering and enumeration in the high-throughput way.

Membraneless separation techniques, such as electrophoresis, acoustic separation, and centrifugation require long analysis time and therefore are not appropriate choices for large volume samples. These techniques also require external fields that can potentially damage cells and biological molecules.

### SUMMARY OF THE INVENTION

The present invention is directed to a microfluidic device for rapid particle enumeration. The microfluidic device comprises an inlet, a microchannel, an outlet, multiple branched channels and a sensing channel. The inlet is for receiving a fluid sample. The fluid sample contains particles, which includes a plurality of first particles. The microchannel has a plurality of loops. Each of the branched channels interconnects at least two adjacent loops. The outlet is for outputting the fluid sample. The first particles migrate toward an inner channel wall of the microchannel when the first particles pass through the outlet. The sensing channel is for receiving the fluid sample from the microchannel. The sensing channel includes a slit pattern for optical particle enumeration of the first particles passing through the sensing channel.

The present invention is also directed to a method for rapid particle enumeration. The method comprises steps of supplying a fluid sample into a microchannel at a flow rate, the microchannel being arranged with a plurality of loops; trapping microbubbles of the fluid sample into a plurality of branched channels, each of the branched channels interconnecting two loops of the plurality of loops; driving a plurality of first particles in the fluid sample to a first equilibrium position depending on the flow rate and the loops when the first particles leave the microchannel and pass through a sensing channel having a slit pattern; and collecting optical signals transmitted through the slit pattern from the first particles to enumerate the first particles in the fluid sample.

The present invention is also directed to a device for particle detection. The device comprises a microchannel, multiple branched channels and a sensing channel. The microchannel has a plurality of loops for a fluid to continuously travel though the loops of the microchannel. Each of the branched channels interconnects at least two loops. The sensing channel has a slit pattern for receiving the fluid from the microchannel and for transmitting optical signals through the slit pattern from particles in the fluid.

### BRIEF DESCRIPTION OF THE DRAWINGS

FIG. 1 illustrates an example of a web-spiral microfluidic device.

FIG. 2 shows an example of a deviating cell position due to a microbubble sticking on the channel wall

FIG. 3 shows an example of a microbubble trapped at a branched channel.

FIG. 4 includes a series of images illustrating a microbubble disappearance process due to the microbubble structure damaged by the presence of the branched channel.

FIG. 5 illustrates forces acting on particles travelling though the microchannel.

FIG. 6 illustrates a slit pattern formed in the sensing portion.

FIG. 7 illustrates the trajectory dependent scattering signals collected by the photodetector.

FIG. 8 shows the histogram of the accumulative intensity of white blood cells.

FIG. 9 illustrates a flow chart for rapid particle enumeration using the web-spiral microfluidic device.

### DETAILED DESCRIPTION OF THE INVENTION

An optical-coding microfluidic device combined with the web-spiral microfluidic device for a real-time diagnosis is disclosed herein. The technology can be extensively used for cell enumeration from a large volume of fluid sample. For instance, the spiked white blood cell sample (˜10,000 cells) in 20 mL of peritoneal fluid can be first concentrated with web-spiral device in a high throughput way. The flow rate can be operated at multiples of ranges such as 0.5-3 mL/min, 1-2 mL/min, 1-3 mL/min, 1.5-4 mL/min, 3-5 mL/min, 4-7 mL/min, 5-9 mL/min, or 4-10. mL/min. The flow rate depends on the particle size. Larger particles reach their equilibrium positions at a higher flow rate.

Leveraging the balance between the lift force and Dean force, the web-spiral device can drive cells with the sizes of interest toward the inner channel wall. On the other hand, the branched channels connecting adjacent loops can effectively trap the microbubbles. Trapping the microbubbles improves the accuracy of the equilibrium positions of cells. The focused cells are examined by the optical-coding technique, which is setup in the downstream channel close to outlet. With the help of special optical-coding pattern, the customized algorithm is allowed to improve signal-to-noise ratio and offers better analysis in terms of sensitivity and accuracy.

### Web-Spiral Microfluidic Device

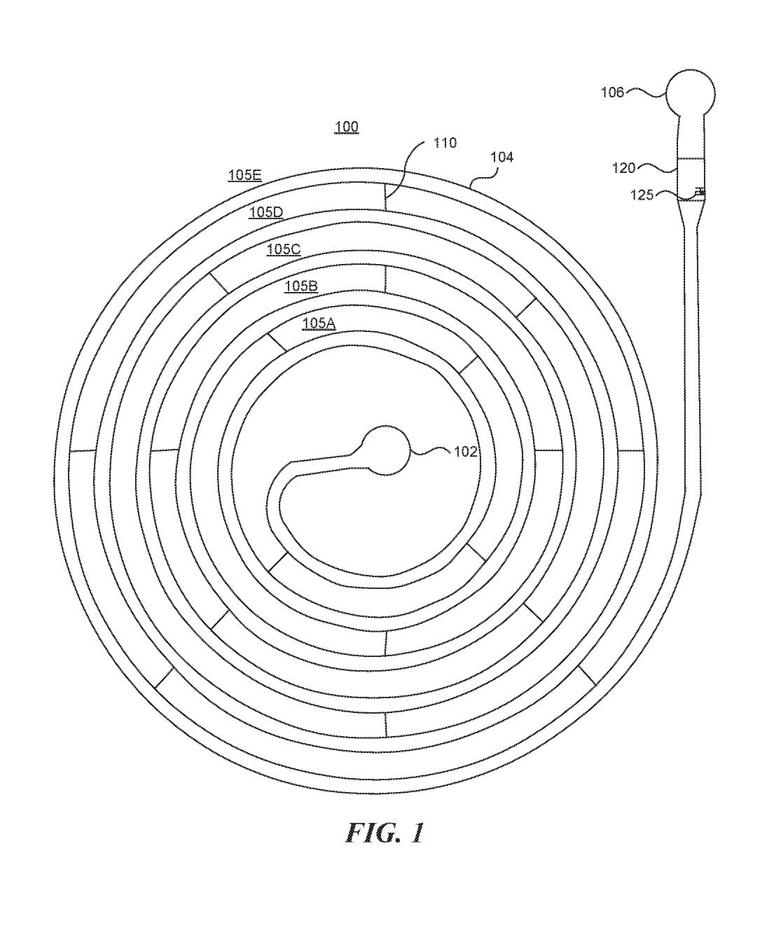

Referring now to the drawings, and particularly to FIG. 1, there is shown a web-spiral microfluidic device according to at least one embodiment. The web-spiral microfluidic device 100 separates microparticles based on size and further enumerate microparticles by sizes in a specific range. The web-spiral microfluidic device 100 comprises an inlet 102 for receiving a fluid sample, a microchannel 104 having a plurality of loops 105A-105E, a plurality of branched channels 110, an outlet 106 and a sensing portion 120. The microchannel 104 and the branched channels 110 can form on a substrate 130 (not shown) using microfabrication techniques such as photolithography technology. Such a device can be referred to as a lab-on-a-chip (LoC) system. The microchannel 104 and the branched channels 110 can be fabricated using plastic materials such as poly-dimethylsiloxane (PDMS), polymethylmethacrolate (PMMA), polycarbonate (PC), cyclic olefin copolymer (COC), acrylonitrile butadiene styrene (PBS), polyvinyl chloride (PVC), or glass.

In one embodiment, the microfluidic devices were fabricated in polydimethylsiloxane (PDMS). The dimensions of microchannel can be 500 μm wide, 50 μm high and about 40 cm long, fabricated using the soft-lithography method using a 50 μm thick layer of SU-8 photoresist as mold or an etched silicon with designed patterns as mold. In some embodiments, the microchannel can have a diameter of from 300 μm to 600 μm, from 500 μm to 800 μm, from 700 μm to 1000 μm, from 900 μm to 1500 μm, from 1400 μm to 1800 μm, or from 1600 μm to 2000 μm. The diameter of the microchannel can depend on the particle size. The diameter and shape of the microchannel can be designed such that particles of a particular size range can reach the equilibrium position within a reasonable time frame. The sensing portion has a cross section with dimensions of 250 μm width, 50 μm height and 200 μm length. After the development of the SU-8 resist, PDMS prepolymer and curing agent in a 10:1 mixing ratio was poured onto the SU-8 mold. At 65° C. for 4 hours, the polymer mixture was cured and the PDMS layer was peeled from the mold. With the oxygen plasma treatment, the PDMS layer was bonded to a glass slide to complete the microfluidic device.

The sensing portion 120 is coupled to the microchannel 104 such that the sample fluid can flow through the microchannel 104 and reach the sensing portion 120. In some embodiments, the sensing portion 120 is a sensing channel extended from the microchannel 104. On the glass slide of the sensing portion, a slit pattern 125 was formed by depositing non-transparent materials such as metal films of Ti/Au or a black color print. For counting the cells, a laser source propagates through the slit-patterned glass slide to interrogate the cells within the microchannel. The forward scattering signals of flowing cells were detected by a Si photodiode placed at about 0.5 to 5 degrees, 2 to 5 degrees, 3 to 6 degrees, 5 to 9 degrees, 8 to 13 degrees, 0.5 to 15 degrees from the optical beam. The optical-coding technique encoded the forward scattering signals that possess the spatial position and velocity information of travelling cells. With the aid of digital signal processing, the signal-to-noise ratio of signals can be significantly improved.

In some embodiments, the position of the slit pattern 125 is adjustable. Depending on the average size of the particles to be detected, the equilibrium position of the particles can vary. The slit pattern 125 can be adjusted along the sensing area based on the particle equilibrium position.

The inlet 102 is configured to receive a sample fluid containing particles of various sizes. For example, the sample fluid can be peritoneal fluid containing bioparticles (e.g., white blood cells) and other particles. The white blood cells can have diameters from 6 μm to 30 μm. The inlet 102 may be connected to ports of other devices, e.g. syringes, to receive the sample fluid and allow it to enter the microchannel 104, to separate particles based on size. In the illustrated embodiment, the web-spiral microfluidic device 100 has only one inlet 102 and one outlet 106. In other embodiments, a web-spiral microfluidic device can have multiple inlets and/or multiple outlets.

The microchannel 104 is arranged in a plurality of loops 105A-105E. The microchannel 104 can be rectangular in cross section, having two horizontal walls and two vertical walls. The inlet 102 and the outlet 106 are located at opposite ends of the microchannel 104. The sensing portion 120 locates between the microchannel 104 and the outlet 106. The sensing portion is configured to detect and count particles when the particles travel out of the microchannel 104 and are about to reach the outlet 106.

The dimensions and parameters of the web-spiral microfluidic device 100 can help to achieve a separation between multiple particle sizes. Smaller particles transpose within the sample fluid due to the Dean force. Larger particles reach equilibrium positions close to the inner wall due to the balance between the inertial lift forces and the Dean drag force. When the particles of difference sizes separate in the loops of the microchannel 104, distinct particle streams based on particle size form and can be collected or analyzed based on their positions.

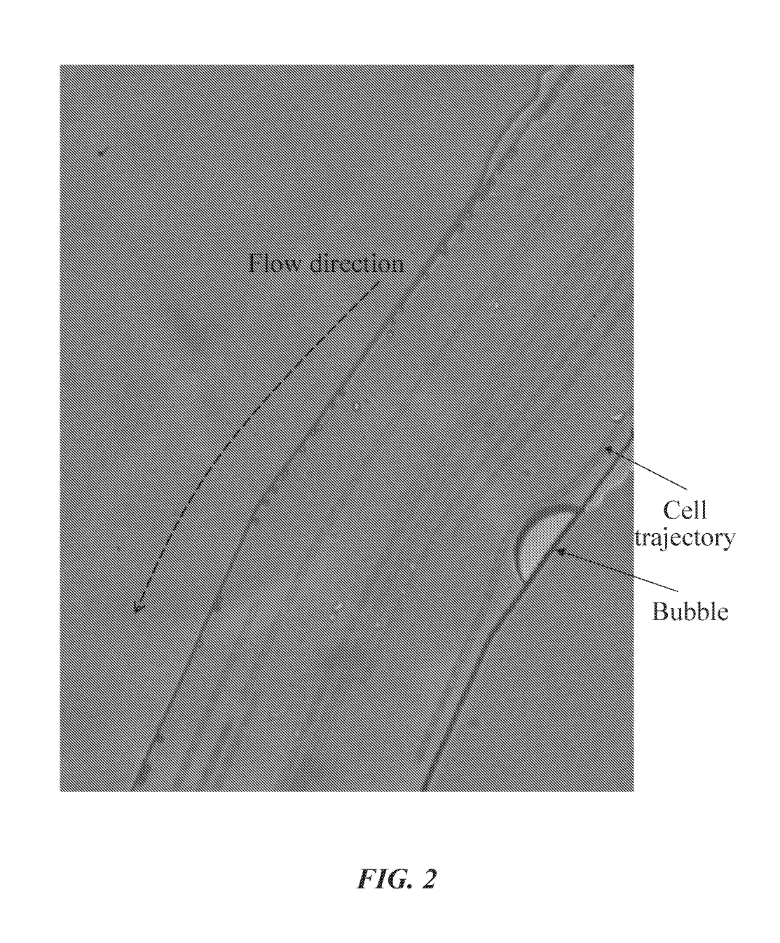

The branched channels 110 can trap the microbubbles which can be introduced when users operate the devices. Microbubbles are generally soft and easy to stick on the channel wall. When sticking to the wall, microbubbles would be hard to get rid of and these microbubbles will change the flow streamline depending on the size of microbubbles. The changed flow streamline causes the cell positions to deviate from the equilibrium positions. As a result, the sensing area in the downstream of channel cannot detect cells of appropriate sizes. FIG. 2, which stacks images recorded by the high speed camera at the area near the inlet, shows an example of deviating cell positions due to a microbubble sticking on the channel wall. The equilibrium positions of cells in the downstream are affected by the presence of microbubbles. Thus, the branched channels 110 trap the microbubbles to avoid the particle positions deviating from the equilibrium positions. The branched channels having various shapes such as straight line shapes, curved shapes, zigzag shapes or other shapes. The dimension of the cross section of a branched channel can also vary. For example, the diameter at ends of a branched channel can be smaller than a diameter at the center of the branched channel.

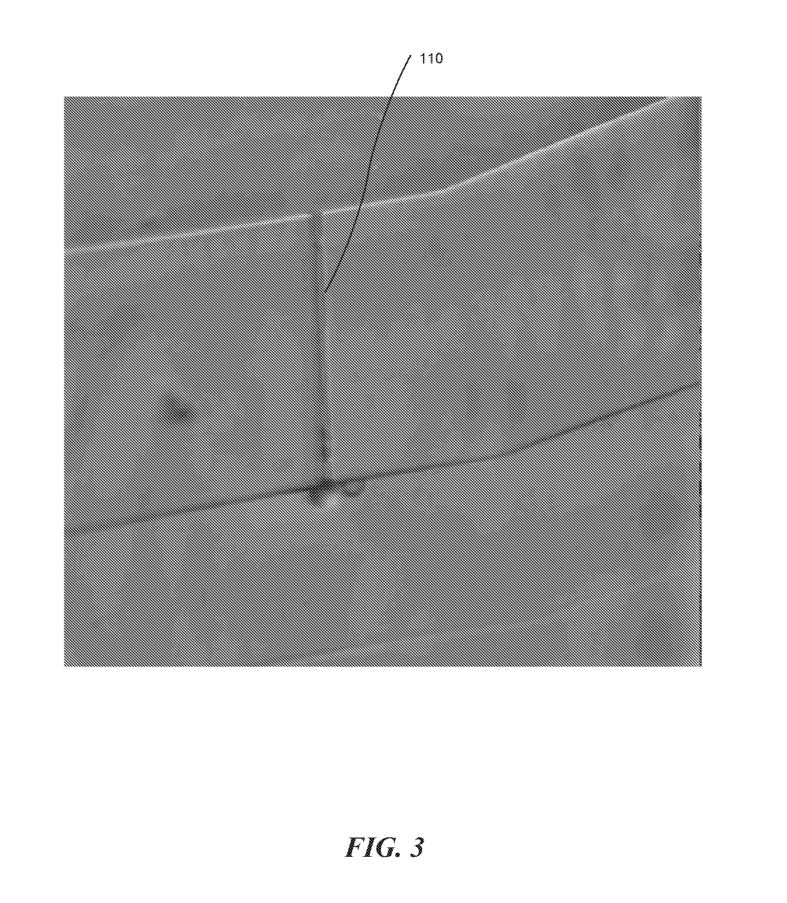

In one embodiment, the diameter of the cross sections of the branched channels 110 can be 10 μm or even less. The diameter can be selected such that flow impedance is large enough so that no significant amount of the sample fluid flows through the branched channels 110. The diameter of the microbubbles can be 6-50 μm, but the volume of microbubbles is compressible under the hydraulic pressure. Thus, the diameter of the branched channels is still large enough to trap the microbubbles. In FIG. 3, a microbubble having a diameter of 25 μm is trapped by the branched channel 110, and will not arrive to the wall at downstream. This is an evidence that the upstream branched channels will help capturing microbubbles and enable the efficacy of 2 hydraulic forces, inertial lift forces and the Dean drag force.

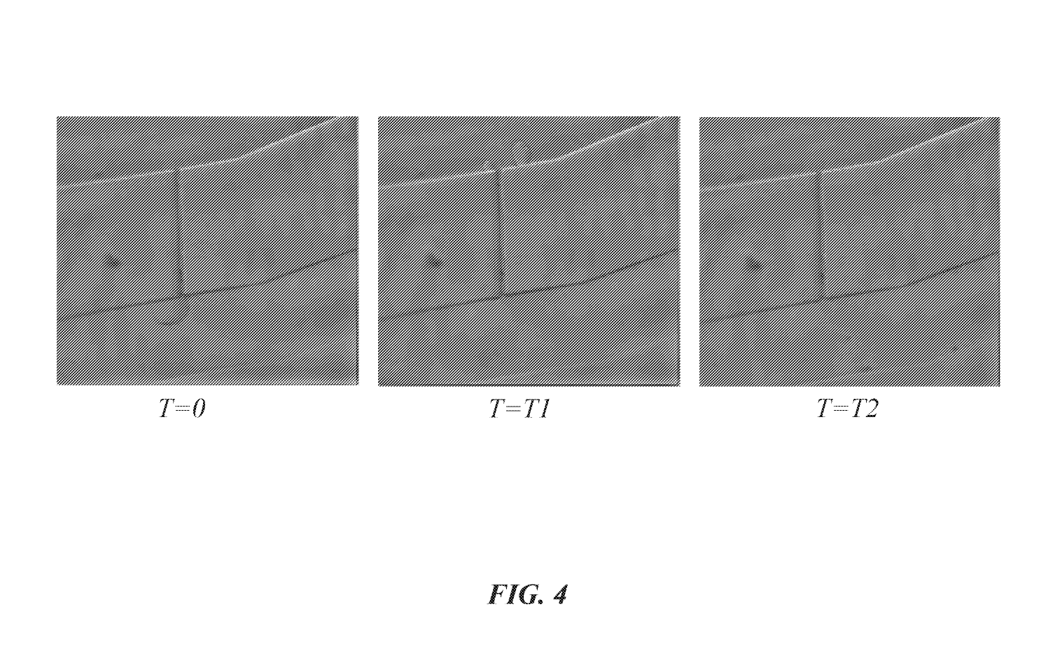

In some other embodiments, the branched channels can be used to damage the structure of microbubbles when the dimension of microbubbles is at least tens of times larger than the diameter of branch channels. For example, FIG. 4 includes a series of snapshots illustrating a microbubble flowing in the web-spiral device. The microbubble is about 180 μm in diameter and trapped by the branched channels in the first place. In a short period, the microbubble penetrates through the branched channel and divides into 2 or more microbubbles. The smaller microbubbles generated by the division are easily washed away by flow stream. Without the branched channel, the microbubble would have adhered onto the side wall and affected the equilibrium position of cells.

In some embodiments, the web-spiral microfluidic device 100 can further include a photodetector for collecting the optical signaled transmitted through the slit pattern from the particles of the fluid. The photodetector has a bandwidth that is appropriate for a frequency of the particles passing through the sensing channel.

Although the illustrated embodiment includes a spiral microchannel having multiple loops, in some other embodiments, the microchannel can have other shapes and can have portions with various designs. The branched channels interconnect different portions of the microchannel to trap the microbubbles.

### Particle Equilibrium

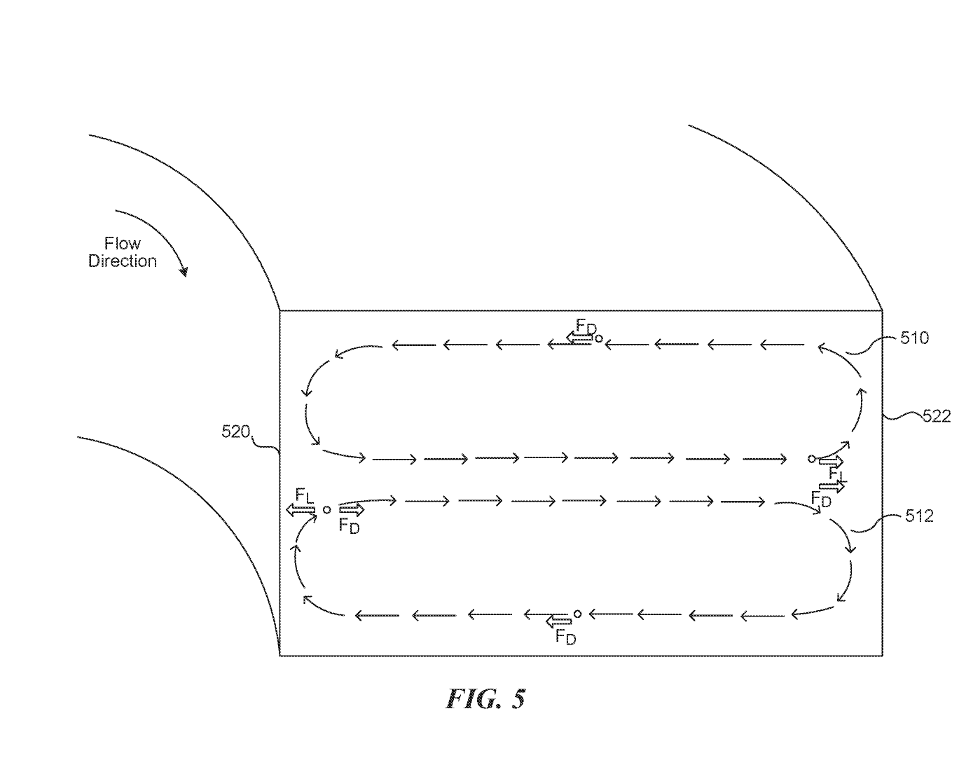

Referring now to FIG. 5, which illustrates forces acting on particles travelling though the microchannel 104. The sample fluid flowing through the microchannel 104 experiences centrifugal acceleration directed radially outward due to the loops 105A-105E. The centrifugal acceleration causes formation of two counter-rotating Dean vortices 510, 512. The vortex 510 is in the upper half of the channel, while the vortex 512 is in the lower half of the channel.

The flows in the Dean vortices depends on the density of fluid medium, average fluid velocity, fluid viscosity, the radius of curvature of the path of the microchannel 104. The higher the curvature, the more Dean flows in the Dean vortices 510 and 512. Particles in the sample fluid experience a Dean force, F_{D}, due to the flows introduced by the Dean vortices. The particles, depending on sizes, circulate along one of the Dean vortices and move toward either inner channel wall 520 or outer channel wall 512.

The particles also experience pressure forces and inertial lift forces in the microchannel 104. The inertial lift force F_{L}, caused by shear forces and the walls, acts on the particles and directs the particles away from the center of the microchannel 104. When the particles are near the microchannel walls, the wall-induced inertial lift force dominates. When the particles are close to the center of the microchannel, the shear-induced inertial lift force dominates. Thus, the particles tend to occupy equilibrium positions where the oppositely directed lift forces are balanced.

As shown in FIG. 5, particles in FIG. 5 tend to travel in one of the two Dean vortices 510 and 512. The particles flowing near the top and bottom walls of the microchannel 104 experience lateral movements due to Dean force, F_{D}. The particles near the top wall are pushed towards the inner wall 520; while the particles near the bottom wall are pushed toward the outer wall 522. Particles near the outer wall 522 experience the lift force F_{L} and the Dean force F_{D} along the same direction, and therefore continue to flow along with the Dean vortices 510 or 512 regardless of particle size.

Particles near the inner wall 520 experience the lift force F_{L} and the Dean drag force F_{D} that act in opposite directions. Depending on the size of the particles (thus different magnitude of F_{L} and F_{D}), the particles either equilibrate at positions close to the inner wall 520 and form a steady steam, or continue to re-circulate in the Dean vortex. The size dependence of the Dean force and inertial lift force are utilized to achieve a steady stream of particles of a particular size range. Other particles that are not in that size range continue to circulate within the Dean vortices. By carefully choosing the geometry of the microchannel 104, the device can cause particles or cells of a particular size to occupy the equilibrium position near the inner wall 520. Thus, the flow of the particles of that size are separated from other particles, and therefore can be used for further analysis such as particle enumeration.

### Particle Detection and Enumeration

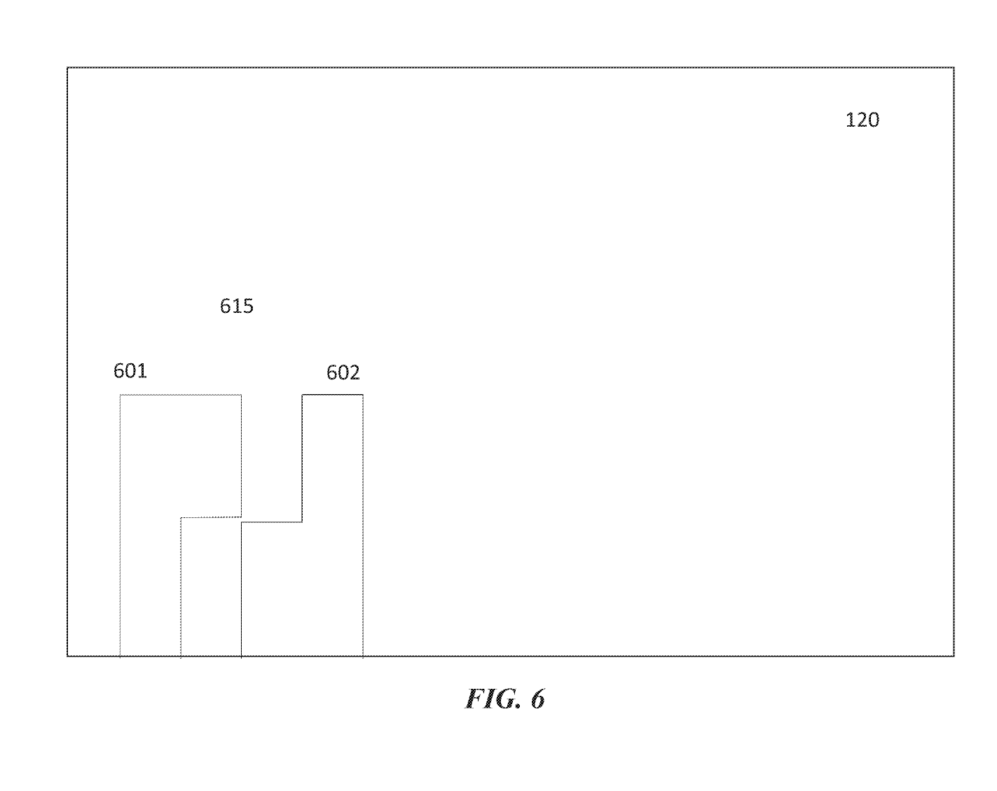

Once the particles of a specific size range reach the equilibrium position, the web-spiral microfluidic device 100 can detect and enumerate the particles at the sensing portion 120. FIG. 6 illustrates a slit pattern 615 formed in the sensing portion 120. The slit pattern 615 can be formed on a glass slide by, e.g., depositing Ti/Au (100 nm/200 nm) metal layers using E-beam evaporation or sputtering deposition and metal lift-off process.

A laser source propagates through the patterned glass slide to detect the cells within the channel. The forward scattering signals of flowing cells were detected by a Si photodiode. The optical-coding technique encoded the forward scattering signals that possess the spatial position and velocity information of travelling cells.

As shown in FIG. 6, the slit pattern has two staircase-shaped slits 601 and 602. In order to effectively count cells or particles in a fast pace, the two-slit staircase-shaped pattern possesses the various advantages. In one embodiment, the staircase-shaped slits 601 and 602 have a width of 100 μm at the longer end and a width of 50 μm at the shorter end. The staircase-shaped slits 601 and 602 are arranged with a separation of about from 25 to 50 μm to form a sensing pattern as shown in FIG. 6. The short sensing area width minimizes overlapping events that are caused by two or more adjacent particles flowing within the sensing area at same time.

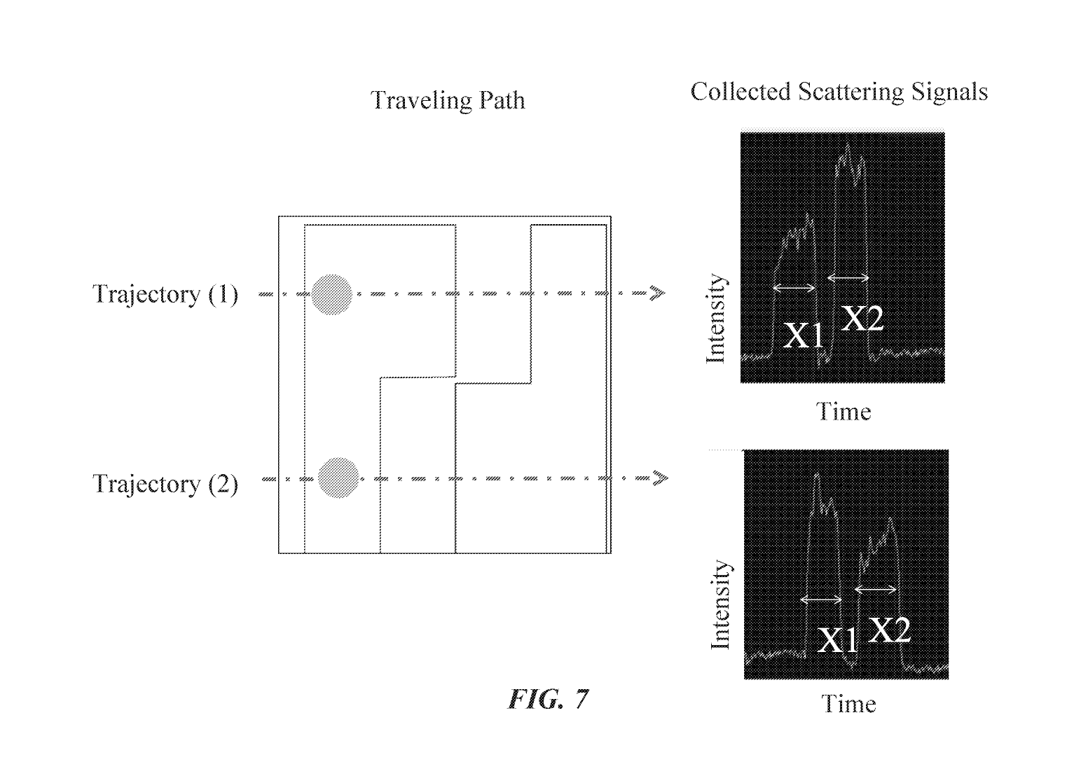

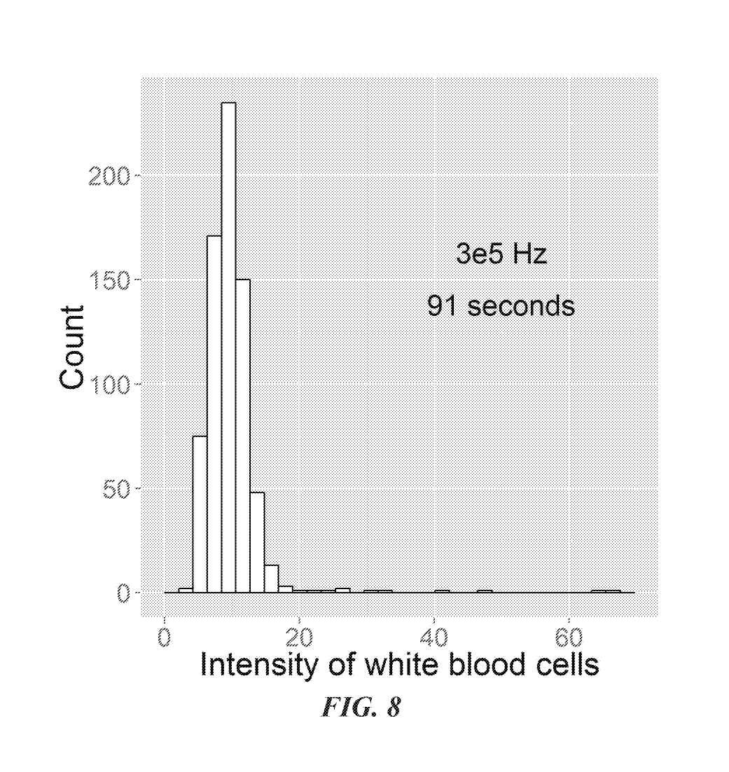

In addition, because of the wide separation of focusing particles' trajectories, the staircase-shaped slits offer the binary output. For example, the width ratio of the peak signals from the first slit to the peak signals from the second slit can be either 0.5 or 2. This ratio leads a simple algorithm that properly resolves the cell counting and prevents ambiguous results. FIG. 7 illustrates the path dependent scattering signals collected by the photodetector. The distinct base length of waveforms indicates the different trajectories, which can be used to resolve trajectory information of cells. FIG. 8 shows the histogram of accumulative intensity of white blood cells after the digital signal processing. The narrow distribution of the accumulative intensity reveals that with the aid of Dean force and lift force, cells in the specific size region are mostly migrated toward the inner channel wall at the sensing area by this invention. This invention also enables a high throughput for the cell enumeration solution to the large volume sample.

The widths of the slits depend upon the size of the particles to be detected. Each of the light-transmissive portion of the slit pattern 615, i.e., the staircase-shaped slits 601 and 602, has a width that is determined such that the frequency of cells or particles travelling over the sensing area f_{cs} is within the bandwidth of photodetector Bₚₕₒ. The f_{cs} is defined as f_{cs}=V_{cell}/Lₛₑₙₛ, wherein V_{cell} is the travelling velocity of the cells or particles, Lₛₑₙₛ is the width of light-transmissive portion of the slit pattern (i.e., the slits).

### Sample Method for Enumerating Particle

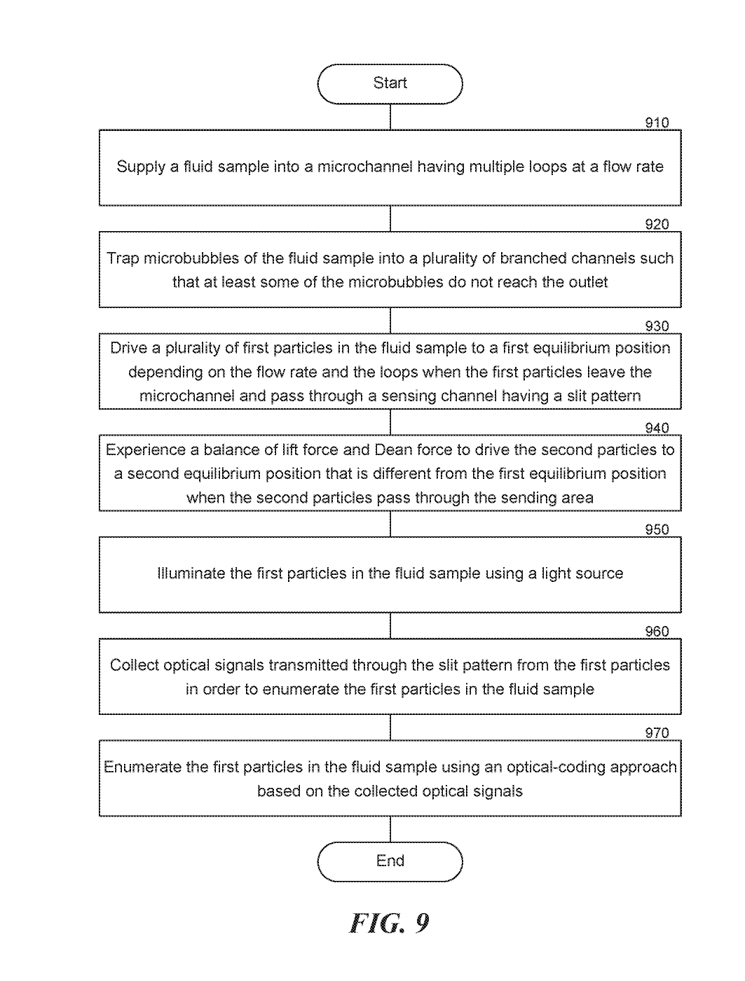

FIG. 9 illustrates a flow chart for rapid particle enumeration using the microfluidic device. The process 900 starts at step 910, where the process supplies a fluid sample into a microchannel at a flow rate. The microchannel is arranged with a plurality of loops.

At step 920, the process traps microbubbles of the fluid sample into a plurality of branched channels such that at least some of the microbubbles do not reach the outlet. Each of the branched channels interconnects two loops of the plurality of loops.

At step 930, the process drives a plurality of first particles in the fluid sample to a first equilibrium position depending on the flow rate and the loops when the first particles leave the microchannel and pass through a sensing channel having a slit pattern. The slit pattern is positioned to allow optical signals from the first particles at the first equilibrium position to pass through. The fluid sample can further include a plurality of second particles that have an average diameter less than an average diameter of the plurality of first particles. The microbubbles are trapped into the branched channels such that the microbubbles do not cause the first particles to substantially deviate from the first equilibrium position when the first particles pass through the sensing channel.

At step 940, the process experiences a balance of lift force and Dean force to drive the second particles to a second equilibrium position that is different from the first equilibrium position when the second particles pass through the sensing area.

At step 950, the process illuminates the first particles in the fluid sample using a light source. At step 960, the process collects optical signals transmitted through the slit pattern from the first particles in order to enumerate the first particles in the fluid sample. AT step 970, the process enumerates the first particles in the fluid sample using an optical-coding approach based on the collected optical signals.

Those skilled in the art will appreciate that the logic illustrated in FIG. 9 and described above may be altered in a variety of ways. For example, the order of the logic may be rearranged, substeps may be performed in parallel, other logic may be included, etc.

The invention, and the manner and process of making and using it, are now described in such full, clear, concise and exact terms as to enable any person skilled in the art to which it pertains, to make and use the same. It is to be understood that the foregoing describes preferred embodiments of the present invention and that modifications may be made therein without departing from the scope of the present invention as set forth in the claims. To particularly point out and distinctly claim the subject matter regarded as invention, the following claims conclude this specification.

1. A microfluidic device for rapid particle enumeration, comprising;
an inlet for receiving a fluid sample, wherein the fluid sample comprises a plurality of first particles;
a microchannel having a plurality of loops to allow the fluid sample to travel from the inlet to the loops of the microchannel;
multiple branched channels, each of the branched channels interconnecting at least two adjacent loops of the plurality of loops; and
a sensing channel, the sensing channel including a slit pattern for optical particle enumeration of the first particles passing through the sensing channel from the microchannel; wherein when the first particles enter the sensing channel, the first particles migrate toward an inner channel wall of the sensing channel and are optically counted.

2. The microfluidic device of claim 1, wherein the fluid sample further comprises microbubbles, and the branched channels trap some of the microbubbles and reduce the number of the microbubbles reaching the sensing channel.

3. The microfluidic device of claim 1, wherein the branched channels trap microbubbles of the fluid sample such that the first particles reach a first equilibrium position close to the inner channel wall when the first particles pass through the sensing channel.

4. The microfluidic device of claim 4, wherein the fluid sample further comprises a plurality of second particles, and when the second particles pass through the sensing channel the second particles reach a second equilibrium position that is different from the first equilibrium position.

5. The microfluidic device of claim 5, wherein the first particles having an average diameter larger than an average diameter of the second particles.

6. The microfluidic device of claim 1, wherein the loops of the microchannel cause lift force and Dean force to the particles in the fluid sample, and a balance of the lift force and the Dean force causes the first particles to reach a first equilibrium position close to the inner channel wall when the first particles pass through the sensing channel.

7. The microfluidic device of claim 1, further comprising:
a light source to illuminate the particles in the fluid sample;
a photodetector to collect optical signals transmitted through the slit pattern from the particles in the fluid sample; and
an outlet for outputting the fluid sample.

8. The microfluidic device of claim 1, wherein the fluid sample further comprises microbubbles, and the branched channels divide some of the microbubbles into smaller microbubbles.

9. A method for enumerating particles by using the microfluidic device of claim 1, comprising:
supplying a fluid sample comprising a plurality of first particles into the microchannel having loops with a flow rate;
trapping microbubbles of the fluid sample into the branched channels of the microfluidic device, each of the branched channels interconnecting two loops of the plurality of loops;
passing the first particles through the sensing channel coupled to the microchannel, the sensing channel having the slit pattern,
driving the first particles to a first equilibrium position depending on the flow rate and dimensions of the loops; and
collecting optical signals transmitted through the slit pattern from the first particles to enumerate the first particles in the fluid sample.

10. The method of claim 9, wherein the trapping step comprises:
trapping the microbubbles into the branched channels such that at least some of the microbubbles do not reach the sensing channel.

11. The method of claim 9, wherein the trapping step comprises:
trapping the microbubbles into the branched channels such that the microbubbles do not cause the first particles to substantially deviate from a first equilibrium position when the first particles pass through the sensing channel.

12. The method of claim 9, wherein the fluid sample further includes a plurality of second particles that have an average diameter less than an average diameter of the plurality of first particles, and the second particles is driven by a balance of lift force and Dean force to a second equilibrium position different from the first equilibrium position.

13. The method of claim 9, wherein the slit pattern is positioned to allow optical signals from the first particles at the first equilibrium position to pass through.

14. The method of claim 9, further comprising:
illuminating the first particles in the fluid sample using a light source; and
enumerating the first particles in the fluid sample using an optical-coding approach based on the collected optical signals.

15. The method of claim 9, wherein the flow rate is between 0.5 mL/min to 10 mL/min and depends on an average size of the first particles.

16. A device for particle detection, comprising;
a microchannel having a plurality of loops for a fluid to continuously travel though the loops of the microchannel;
multiple branched channels, each of the branched channels interconnecting at least two loops of the plurality of loops; and
a sensing channel having a slit pattern for receiving the fluid from the microchannel and for transmitting optical signals through the slit pattern from particles in the fluid.

17. The device of claim 16, wherein the branched channels trap microbubbles from the fluid such that the microbubbles do not cause the particles in the fluid to substantially deviate from an equilibrium position when the particles pass through the sensing channel.

18. The device of claim 16, wherein the slit pattern is a staircase-shaped pattern including multiple light-transmitting slits, the light-transmitting slits having lengths to reduce overlapping events that are caused by adjacent particles passing though the sensing channel at the same time, and the staircase-shaped pattern causes a binary output for the collected optical signals.

19. The device of claim 16, further comprising:
a photodetector for collecting the optical signaled transmitted through the slit pattern from the particles of the fluid;
wherein the photodetector has a bandwidth that is appropriate for a frequency of the particles passing through the sensing channel, and the frequency of the particles passing through the sensing channel depends on a travelling velocity of the particles and a length of the sensing channel.

20. The device of claim 16, wherein the microchannel has an average inside diameter of from 300 micrometers to 2000 micrometers.
